(19) United States
(12) Patent Application Publication
(10) Pub. No.: US 2006/0254441 A1
(43) Pub. Date: Nov. 16, 2006

(54) Register adjustment apparatus for varnishing unit

(75) Inventors: Shizuo Masuda, Shizuoka (JP); Shigeki Irie, Shizuoka (JP)

Correspondence Address: Ladas & Parry, 26 West 61st Street, New York, NY, 10023, US

(73) Assignee: SHINOHARA MACHINERY CO., LTD.

(21) Appl. No.: 11/416,306

(22) Filed: May 2, 2006

(30) Foreign Application Priority Data
May 11, 2005 (JP) 2005-138273

(51) Int. Cl. B41F 5/16

(52) U.S. Cl. 101/183

(57) ABSTRACT

The present invention relates to register. adjustment apparatus for varnishing unit and, specifically, aims at virtually executing register adjustment in relation to varnishing unit which does not comprise register adjustment means in itself
For this purpose, varnishing unit select button 38a for virtually selecting varnishing unit 26 as control object and adjustment program for varnishing unit are provided in register adjustment apparatus for printing unit 10. Register deviation which is input from numerical input button group 40 is converted in order to work register adjustment means 20 of printing unit 10 as needed. Thereby, machine production cost can greatly be reduced and aesthetic varnish coating can be done, because virtual register adjustment is executed by utilizing register adjustment means of printing unit.

### BACKGROUND OF THE INVENTION

1.1 Field of the Invention

The present invention relates generally to sheet-fed printing press, or more precisely, to register adjustment apparatus for varnishing unit which is connected in line to the press.

2. Description of the Prior Art

In multi-color sheet-fed printing press, a number of printing units are connected in series and, in succession to the printing units, varnishing unit for coating the printed sheet is further connected in line. Such printing press with varnish coater is now watched. Varnish coating is now shifting from rough work of vague positioning into cutting-edge work of strict coating on the determined position of the printed sheet. Such tendency is in the nature of things, as aesthetic printed matter with higher added value is expected by varnish coating.

As is well known in the art, each plate cylinders of printing units are equipped with register adjustment means and strictly registered by order signal from console so that each colors are exactly printed on the sheet in order. But, things are quite different with regard to register adjustment of varnishing unit. Varnish to be coated is, after transferred to varnishing cylinder (with flexible surface layer), coated on the sheet by the varnishing cylinder to which is required adjustment function such as throw-in and throw-out of the cylinder. Therefore, it is not wise to further provide register adjustment means on the varnishing cylinder just like plate cylinder of printing unit, because such construction will be extremely complex and resulted in expensive investment.

In Japanese published unexamined specification No. 54850/1985, an example of sheet-fed printing press with varnishing unit in line is shown, but not described on register adjustment of varnishing unit.

As mentioned above, there is a tendency to obtain aesthetic printed matter with higher added value by strictly executing the work, it is not advisable to provide register adjustment means on varnishing unit itself. On the other hand, register adjustment means with abundant efficiency is usually equipped on printing unit and such means is integrally controlled from console with abundant arithmetic and control function.

### SUMMARY OF THE INVENTION

In view of above-described problems of prior art technique, the present invention aims at an improved register adjustment apparatus for varnishing unit which does not comprise register adjustment means within itself.

In accordance with register adjustment apparatus for varnishing unit of the present invention, select button for varnishing unit which virtually selects varnishing unit as control object and adjustment program for varnishing unit are prepared in register adjustment apparatus for printing units. Register deviation which is input from numerical input button group is converted in order to work register adjustment means of printing units as needed.

By utilizing register means for printing units, virtual register adjustment for varnishing unit is executed as if the adjustment is arisen from varnishing unit itself.

These and other objects of the invention will become apparent from the following description with reference to the drawings. But, these show merely an embodiment of the present invention.

### BRIEF DESCRIPTION OF THE DRAWINGS

FIG. 1 is a conceptual view showing register adjustment apparatus according to the present invention.

FIG. 2 is a plan view showing input means of console.

FIG. 3 is an image diagram showing process of register adjustment.

FIG. 4 is a flowchart of register adjustment for printing unit.

FIG. 5 is a flowchart of register adjustment for varnishing unit.

### DESCRIPTION OF PREFERRED EMBODIMENT

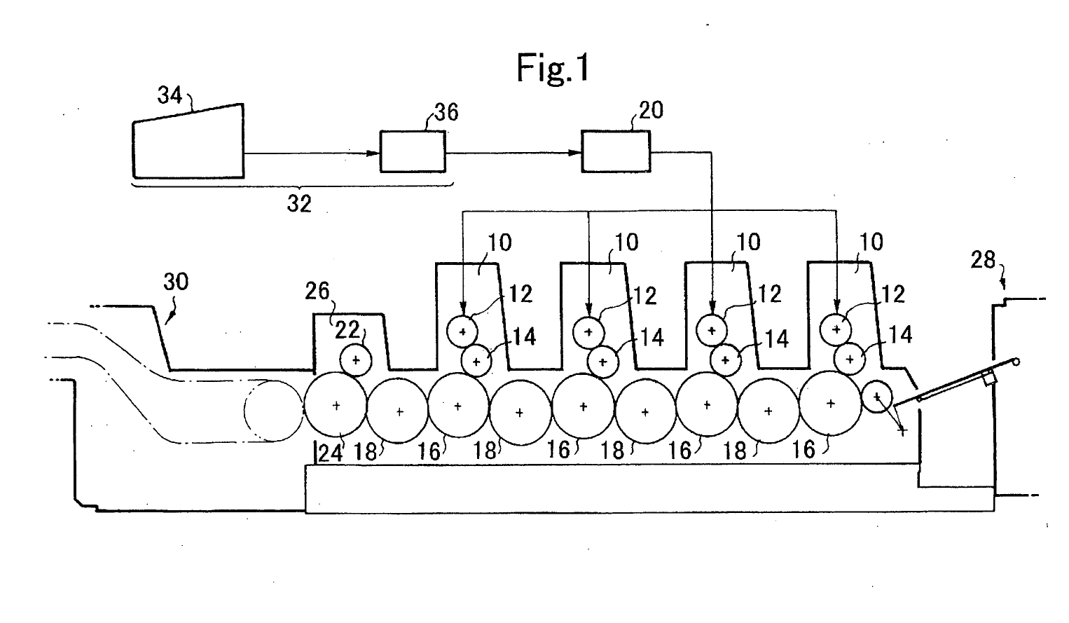

An embodiment of register adjustment apparatus according to the present invention is detailed herein-under with reference to the drawings. FIG. 1 conceptually shows sheet-fed printing press equipped with register adjustment apparatus for varnishing unit and four printing units 10 for multi-color printing are coupled in series. These printing units 10 by offset printing technique comprise plate cylinder 12, blanket cylinder 14 and pressure cylinder 16. Each pressure cylinders 16 are linked by transfer cylinder 18 for sheet transportation. Usually, register adjustment means 20 (represented by a block for simplicity) is provided in each plate cylinders 12. Register adjustment in vertical/horizontal/distortion directions of sheet is already well known in detail.

In succession to fourth color printing unit 10, varnishing unit 26 with varnishing cylinder 22 and opposing pressure cylinder 24 is provided and varnishing is executed on the printed sheet so as to obtain aesthetic printed matter with higher added value. Numerals 28, 30 each designate sheet feeder and delivery.

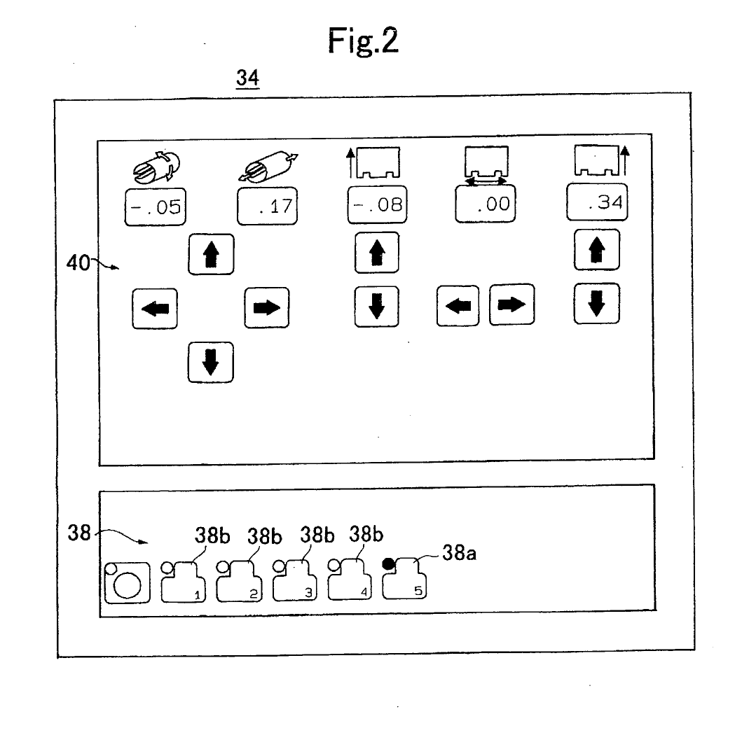

FIG. 2 is a plan view showing input means 34 on the surface of console 32 which has, in addition to the input means 34, abundant arithmetic and control means 36, materially, is computer with CPU, memory and so forth. Within this arithmetic and control means 36, adjustment program for varnishing unit is housed in addition to that of for printing unit. In input means 34, unit select button group 38 at the lower part of the figure are for selecting the unit to be adjusted and fifth button 38a at the right side is for selecting varnishing unit 26 and other buttons 38b are for selecting printing units 10. Numerical input button group 40 at higher part of FIG. 2 are used to input register error between printing units 10 and varnishing unit 26 (in other words, amount of deviation to be adjusted). Buttons at left side of the figure are used to input deviation of vertical/horizontal directions and that of right side is for deviation. Numerical display is executed in compliance with depression of buttons.

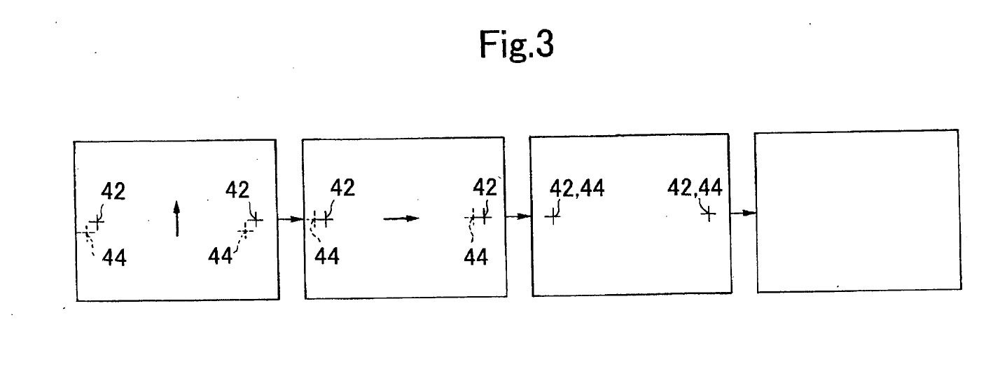

FIG. 3 is a diagram showing the process of register adjustment from left to right. In cross-shaped marks (register marks) 42, 44, solid ones 42 are by printing unit 10 and dotted ones 44 are by varnishing unit 26. Not to mention, modes of register error are multifarious, therefore, very simple example is shown in the figure. Vertical/horizontal errors at left side of the figure are adjusted in up and right directions to bring these cross marks 42, 44 into coincidence and complete register is finally obtained just as shown in the right of figure.

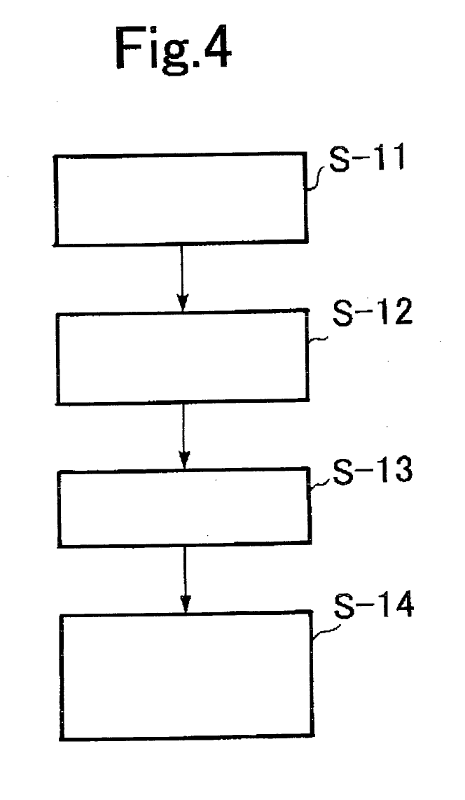

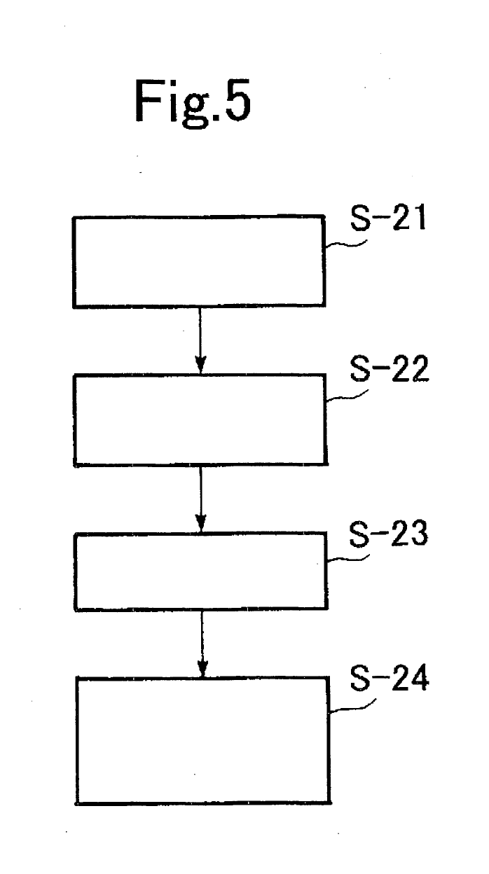

FIGS. 4 and 5 are flowcharts showing register adjustment processes by printing unit 10 and varnishing unit 26. In case of register adjustment of printing unit 10, as is well known, select button 38b (one of 1 to 4 in unit select button group 38 in FIG. 2) is depressed (Stage-11). Then, printing unit adjustment program is call in arithmetic and control means 36 (Stage-12). When the amount of register deviation is input from numerical input button group 40 (Stage-13), register adjustment means 20 of printing unit 10 works in accordance with the input value (Stage-14).

In case register adjustment for varnishing unit 26 is necessary, varnishing unit select button 38a (button 5 in FIG. 2) of unit select button group 38 is depressed (Stage-21). Then, varnishing unit adjustment program housed in arithmetic and control means 36 is called upon (Stage-22). In this case, however, when register deviation to be adjusted for varnishing unit 26 is input from numerical input button group 40 (Stage-23), the input value is converted according to characteristic formula and, based upon the converted value, register adjustment means 20 of printing unit 10 works (Stage-24). These adjustments are repeated as the need arises and production run finally begins. In accordance with varnishing unit adjustment apparatus, virtual register adjustment can be executed with regard to varnishing unit which has not register adjustment means itself by utilizing that of printing unit. Therefore, machine production cost can be greatly reduced and aesthetic varnishing is enabled.

The present invention is not limited to the embodiment described hitherto. Various changes and modification can, of course, be made without departing from the spirit of the invention.

### DESCRIPTION OF THE REFERENCE NUMERALS

10 printing unit

12 plate cylinder

20 register adjustment means

22 varnishing cylinder

26 varnishing unit

32 console

34 input means

36 arithmetic and control means

38 unit select button group

38a select button for varnishing unit

38b select button for printing unit

40 numerical input button group

What is claimed is:

1. In a sheet-fed printing press in which numbers of printing units 10 equipped with register adjustment means 20 and varnishing unit 26 are connected in line, said printing units 10 being integrally controlled by console 32, register adjustment apparatus for varnishing unit comprising; select button 38a for said varnishing unit 26 in addition to select button 38b for said printing units 10 in said console 32 and adjustment program for varnishing unit in addition to that of for printing unit in arithmetic and control means 36 in said console 32 and in case said select button 38a of varnishing unit 26 is depressed, said adjustment program for varnishing unit is called upon and input value from numerical input button group 40 is converted to actuate register adjustment means 20 of printing units 10 as needed.
